(19) United States
(12) Patent Application Publication
(10) Pub. No.: US 2009/0075828 A1
(43) Pub. Date: Mar. 19, 2009

(54) INTEGRATED PROTEIN CHIP ASSAY

(75) Inventors: Anna Astriab Fisher, Durham, NC (US); Bryce P. Nelson, Madison, WI (US)

Correspondence Address: Casimir Jones, S.C., 440 Science Drive, Suite 203, Madison, WI, 53711, US

(73) Assignee: GENTEL BIOSURFACES, INC., Madison, WI (US)

(21) Appl. No.: 12/212,344

(22) Filed: Sep. 17, 2008

Related U.S. Application Data
(60) Provisional application No. 60/972,928, filed on Sep. 17, 2007.

(51) Int. Cl. C40B 30/00; C40B 40/10; C40B 60/12

(52) U.S. Cl. 506/7; 506/18; 506/39

(57) ABSTRACT

The present invention relates to novel methodologies for performing multiplexed assays with high precision and sensitivity. In particular, the present invention relates to improving assay sensitivity and precision by combining the normalization of multiplexed assay data using an internal standard with scattered application of samples and standards replicates throughout sample wells on a slide or set of slides as well as scattered replicates of arrayed probes in a single well. These compositions and methods can be used to perform multiplexed assays for analytes in patient and other test samples. In particular, these methods have applications for Quantitative Multi-analyte Immunoassays (QMI) to measure proteins in human serum and plasma.

This application claims the benefit of U.S. Prov. Appl. 60/972,928, filed Sep. 17, 2007, the entire contents of which are incorporated herein by reference.

### FIELD OF THE INVENTION

The present invention relates to novel methodologies for performing multiplexed assays with high precision and sensitivity. In particular, the present invention relates to improving assay sensitivity and precision by combining the normalization of multiplexed assay data using an internal standard with scattered application of samples and standards replicates throughout sample wells on a slide or set of slides as well as scattered replicates of arrayed probes in a single well. These compositions and methods can be used to perform multiplexed assays for analytes in patient and other test samples. In particular, these methods have applications for Quantitative Multi-analyte Immunoassays (QMI) to measure proteins in human serum and plasma.

### BACKGROUND OF THE INVENTION

The ability to perform multiplexed protein measurements on large numbers of patient samples is useful for identifying and evaluating proteins with potential disease relevance and enabling critical decision making. The search for protein biomarkers with predictive value for disease requires multi-protein assays and large sample sets. quantitative multi-analyte immunoassays (QMI) provide one approach to the simultaneous quantification of many proteins in a single sample. Significant progress has recently been made using QMI technology to meet the quantitation, precision, accuracy, and automation requirements for protein expression measurements in saliva, blood, plasma, serum, urine, or other biological fluids.

Multiplexed assays have been commonly used for more than a decade, and have already found many important uses in research including gene expression analysis, high-throughput screening, and drug discovery. A multiplexed assay includes any assay where multiple analytes are measured in a single sample. Multiplexed assays can be performed using a variety of methods, including planar arrays, bead-based formats, microfluidics, and others. Multiplexed assays benefit research because they greatly increase throughput, use very little reagent/sample, and eliminate separation steps of an assay. Planar arrays (also called microarrays, biochips, or chips) generally comprise a collection of multiple probes arranged on a surface. Spatially addressable probes immobilized on a planar surface form an array and can be used to target multiple analytes in a single sample. When a sample is applied to the array, target analytes (e.g. serum proteins) are captured by immobilized probes. The captured target analyte may have been pre-labeled to enable array readout using a microarray scanner or CCD-containing instrument. Some of the most commonly used multiplexed measurements include DNA arrays that capture complementary DNA, complementary RNA, or DNA binding molecules. More recently, arrays have been developed for proteins captured by antibody, peptide, protein, aptamer, or other capture agents.

Discovery and validation of protein biomarkers can be an arduous process requiring multiple protein assays and large sample sets. Many potential biomarkers are often found at very low concentrations making them very difficult to accurately and reproducibly quantify in plasma and serum, and other patient samples. Thus, there is a critical need for multiplexed assays to accurately and precisely quantify the abundance of proteins at physiological concentrations.

Expectations of validation for these biomarkers for use in a clinical or drug development setting are very high, and the capability of current protein microarray technologies to meet these expectations is very limited. Many of these expectations are outlined in documents developed in cooperation with the FDA (e.g., Drug-Diagnostic Co-Development Concept Paper, Department of Health and Human Services (HHS), Food and Drug Administration, April 2005; Guidance for Industry Bioanalytical Method Validation, U.S. Department of Health and Human Services, Food and Drug Administration, Center for Drug Evaluation and Research (CDER), Center for Veterinary Medicine (CVM), May 2001) and Evaluation Methods and Analytical Performance Characteristics of Immunological Assays for Human Immunoglobulin E (IgE) Antibodies of Defined Allergen Specificities; Approved Guideline, NCCLS DocumentI/LA20-A Vol 17 No 24. December 1997). As outlined in these and other documents, any assay that is to be considered for use in a drug development or clinical setting must be successfully validated for the fundamental parameters of accuracy, precision, selectivity, sensitivity, reproducibility, and stability. Among the most important performance attributes, an assay should meet minimal performance criteria based on accuracy, precision, and analyte recovery.

Reasons for current limitations of multiplexed protein measurements vary, but major contributors include variation in printing of protein microarrays—printed arrays can vary spot-to-spot, well-to-well, slide-to-slide, and run-to-run; variation in the conjugation of protein probes to surfaces, including beads; variation in surface chemistry that occurs within a slide, between slides, or within or between beads; variation in reagent mixing and handling, particularly when assays are performed by hand. In particular, variation occurs between days and between operators; Variation in detection instruments (particularly laser-based instruments)—including day-to-day variation between instruments as well as variation of a single instrument; and lack of sufficiently sensitive methods to quantify physiologically relevant levels of important proteins.

In order to meet the need for discovery and validation of protein biomarkers in a drug development and/or clinical setting, new multiplexed protein assay methods must be developed that overcome these limitations.

### SUMMARY OF THE INVENTION

The present invention relates to novel methodologies for performing multiplexed assays with high precision and sensitivity. In particular, the present invention relates to improving assay sensitivity and precision by combining the normalization of multiplexed assay data using an internal standard with scattered application of samples and standards replicates throughout sample wells on a slide or set of slides as well as scattered replicates of arrayed probes in a single well. These compositions and methods can be used to perform multiplexed assays for analytes in patient and other test samples. In particular, these methods have applications for Quantitative Multi-analyte Immunoassays (QMI) to measure proteins in human serum and plasma.

For example, in some embodiments, the present invention provides a method for performing an assay, comprising performing a multiplexed assay for detection of a biological macromolecule using an internal normalization standard (e.g., β-galactosidase) under conditions such that the concentration of the internal normalization standard is used to normalize assay results across different locations of the array. In some embodiments, the assay is a multiplexed assay (e.g., a microarray). In some embodiments, the assay is an immunoassay.

The present invention further provides a method for performing an assay, comprising contacting a substrate comprising at least one (e.g., two or more) microarray with a test sample, wherein the microarray comprises a plurality of replicate assay components located on the microarray, wherein the replicate assay components are scattered across individual location on the microarray. In some embodiments, the microarray is a slide or a cassette. In some embodiments, the assay components are positive control assay components or test assay components. In some embodiments, the test samples are applied in replicate scattered across the at least one microarray. In some embodiments, the method further comprises the step of contacting the microarray with a plurality of standards, wherein the standards are applied in replicate scattered across the at least one microarray. In some embodiments, the method further comprises the step of adding a normalization reagent (e.g., P-galactosidase) to each of the locations on the microarray. In some embodiments, each of the test samples comprises a quality control standard.

The present invention further comprises a substrate comprising at least one (e.g., two or more) protein microarray, the microarray comprising a plurality of replicate assay components located on the microarray, wherein the replicate assay components are scattered across individual location on the microarray.

The present invention additionally provides kits and systems comprising the substrates. For example, in some embodiments, the present invention also provides a kit comprising a substrate for performing a protein microarray, the substrate comprising at least a first (e.g., two or more) microarray comprising a plurality of replicate assay components (e.g., positive control assay components or test assay components such as proteins or antibodies) located on the microarray, wherein the replicate assay components are scattered across individual location on the microarray. In some embodiments, the kit further comprises a normalization reagent (e.g., β-galactosidase). In some embodiments, the kit further comprises a software program configured to analyze microarray image data generated from the array.

In yet other embodiments, the present invention provides a system for performing a microarray assay, comprising a plurality of assay components (e.g., positive control assay components or test assay components such as proteins or antibodies); a substrate for performing a microarray assay, wherein the substrate comprises at least a first microarray comprising a plurality of replicate assay components located on the microarray, wherein the replicate assay components are scattered across individual location on the microarray; and a normalization reagent (e.g., β-galactosidase). In some embodiments, the system further comprises an automation device configured for automation of the generation of the microarray. In some embodiments, the system further comprises software for analysis of the assay. In some embodiments, the kits and systems of the present invention comprise additional components necessary, useful, or sufficient for performing the described assays (e.g., additional reagents, buffers, controls, instructions for performing and analyzing data, and the like).

Additional embodiments of the invention are describing in the following sections.

### DESCRIPTION OF THE FIGURES

FIG. 1 shows normalization using a Positive Control.

FIG. 2 shows scattered spot replicates. Spots are scattered within an array, rather than spotted linearly to reduce intra-slide bias.

FIG. 3 shows an exemplary experimental layout of scattered layout of samples on chips

FIG. 4 shows an exemplary 4-slide Cassette (SIMplex 64 Multi-Array System, GenTel BioSciences). Used to separate samples into sixteen separate chambers during incubation and wash steps for four slides.

FIG. 5 shows the results of an experiment where QC points are spiked into plasma or serum at high, medium, and low concentrations relative to physiological concentration as quality control for the assay.

FIG. 6 shows standard curves showing a comparison between methods of embodiments of the present invention and previous methods.

FIG. 7 shows a Der p 2 standard curve generated using an assay of embodiments of the present invention.

### DEFINITIONS

As used herein, the term “solid surface” refers to any solid surface suitable for the attachment of biological molecules and the performance of molecular interaction assays. Surfaces may be made of any suitable material (e.g., including, but not limited to, metal, glass, and plastic) and may be modified with coatings (e.g., metals or polymers).

As used herein, the term “substrate” refers to any material with a surface that may be coated with a film.

As used herein, the phrase “coated with a film” in regard to a substrate refers to a situation where at least a portion of a substrate surface has a film attached to it (e.g. through covalent or non-covalent attachment).

As used herein, the term “microarray” refers to a solid surface comprising a plurality of addressed biological macromolecules (e.g., nucleic acids or antibodies). The location of each of the macromolecules in the microarray is known, so as to allow for identification of the samples following analysis.

As used herein, the term “microfluidics channels” or “etched microchannels” refers to three-dimensional channels created in material deposited on a solid surface. In some embodiments, microchannels are composed of a polymer (e.g., polydimethylsiloxane). Exemplary methods for constructing microchannels include, but are not limited to, those disclosed herein.

As used herein, the term “one-dimensional line array” refers to parallel microfluidic channels on top of a surface that are oriented in only one dimension.

As used herein, the term “two dimensional arrays” refers to microfluidics channels on top of a surface that are oriented in two dimensions. In some embodiments, channels are oriented in two dimensions that are perpendicular to each other.

As used herein, the term “microchannels” refers to channels etched into a surface. Microchannels may be one-dimensional or two-dimensional.

As used herein, the term “biological macromolecule” refers to large molecules (e.g., polymers) typically found in living organisms. Examples include, but are not limited to, proteins, nucleic acids, lipids, and carbohydrates.

As used herein, the term “target molecule” refers to a molecule in a sample to be detected. Examples of target molecules include, but are not limited to, oligonucleotides (e.g. containing a particular DNA binding domain recognition sequence), viruses, polypeptides, antibodies, naturally occurring drugs, synthetic drugs, pollutants, allergens, affector molecules, growth factors, chemokines, cytokines, and lymphokines. As used herein, the term “target nucleic acid sequence” refers to a nucleic acid sequence known to be, or suspected of being, a transcription factor recognition target sequence.

As used herein, the term “binding partners” refers to two molecules (e.g., proteins) that are capable of, or suspected of being capable of, physically interacting with each other. As used herein, the terms “first binding partner” and “second binding partner” refer to two binding partners that are capable of, or suspected of being capable of, physically interacting with each other.

The term “sample” as used herein is used in its broadest sense and includes, but is not limited to, environmental, industrial, and biological samples. Environmental samples include material from the environment such as soil and water. Industrial samples include products or waste generated during a manufacturing process. Biological samples may be animal, including, human, fluid (e.g., blood, plasma and serum), solid (e.g., stool), tissue, liquid foods (e.g., milk), and cell lysates (e.g., cultured cell lysates).

The term “test compound” refers to any chemical entity, pharmaceutical, drug, and the like that is suspected of altering the affinity of a transcription factor for its target sequence. Test compounds comprise both compounds known to alter such interactions, and those suspected to. A test compound can be determined to be active in altering binding interactions by screening using the screening methods of the present invention.

Where “amino acid sequence” is recited herein to refer to an amino acid sequence of a naturally occurring protein molecule, “amino acid sequence” and like terms, such as “polypeptide” or “protein” are not meant to limit the amino acid sequence to the complete, native amino acid sequence associated with the recited protein molecule.

As used herein the term “accuracy” describes the closeness of mean test results obtained by the method to the true value (concentration) of the analyte. In some embodiments, accuracy is determined by replicate analysis of samples containing known amounts of the analyte, such as independently analyzed validated serum or plasma samples. In some embodiments, it is preferred that the mean value should be within 15% of the actual value except at the lowest limit of quantitation, and generally not deviate by more than 20%.

As used herein, the term “precision” refers to the reproducibility of analyte measurements when a method is applied repeatedly to multiple aliquots of a single sample. In some embodiments, it is preferred that the precision determined at each concentration level should not exceed 15% of the coefficient of variation (CV) except at the lowest limit of quantitation, where it should not exceed 20% of the CV.

As used herein, the term “recovery”, as applied to the recovery of an analyte in an assay, refers to the detector response obtained from an amount of the analyte added to and extracted from the biological matrix divided by the detector response obtained for the true concentration of the pure authentic standard. In some embodiments, recovery experiments are performed by comparing the results for extracted samples at three concentrations (low, medium, and high) with unextracted standards that represent 100% recovery. In general, the extent of recovery of an analyte and of the internal standard should be accurate (e.g., generally a range of 80-120% is commonly regarded as acceptable).

As used herein, the term “analyte” refers to the component of a sample to be analyzed. With respect to protein chip analysis, the analytes are typically proteins.

As used herein, the term “detection reagent” refers to any reagent suitable for detection of the results of an assay (e.g., binding of one biological molecule to another, action of an enzyme on a substrate, etc.) In some embodiments, a detection reagent is a light-reflecting substance that will bind or otherwise interact with an antibody or antigen. In fluorescence based assays, the detection reagent produces the fluorescence values obtained by the scanning instrumentation.

As used herein, the term “standard” refers to an analyte that provides a basis for comparison in an experiment. In some embodiments, standards contain a set of known molecules (e.g., proteins) in known concentrations. When an experiment is run, the standard and the sample are analyzed together. The detection (e.g., luminance) values produced by the sample are compared to those of the standard, yielding the concentration values for the sample.

As used herein, the term “matrix effect” refers to the effect of overall composition of a sample on the analytes of one component of the sample. In some embodiments, matrix effect is defined as the negative effect on the chip performance in a complex matrix such as serum or plasma.

As used herein, the term “antigen” refers to any agent (e.g., any substance, compound, molecule [including macromolecules], or other moiety), that is recognized by an antibody, while the term “immunogen” refers to any agent (e.g., any substance, compound, molecule [including macromolecules], or other moiety) that can elicit an immunological response in an individual. These terms may be used to refer to an individual macromolecule or to a homogeneous or heterogeneous population of antigenic macromolecules. It is intended that the term encompasses protein and peptide molecules or at least one portion of a protein or peptide molecule, which contains one or more epitopes. In many cases, antigens are also immunogens, thus the term “antigen” is often used interchangeably with the term “immunogen.” The substance may then be used as an antigen in an assay to detect the presence of appropriate antibodies in the serum of the immunized animal.

The term “specific for” when used in reference to the interaction of an antibody and a protein or peptide means that the interaction is dependent upon the presence of a particular structure (i.e., the antigenic determinant or epitope) on the protein; in other words the antibody is recognizing and binding to a specific protein structure rather than to proteins in general (i.e. non-specific or background binding).

The term “not reactive with” when used in reference to the potential interaction of an antibody and a protein or peptide means that the antibody does not recognize or bind specifically to that particular protein (i.e. binding is at background levels).

### DETAILED DESCRIPTION OF THE INVENTION

The present invention relates to novel methodologies for performing multiplexed assays with high precision and sensitivity. In particular, the present invention relates to improving assay sensitivity and precision by combining the normalization of multiplexed assay data using an internal standard with scattered application of samples and standards replicates throughout sample wells on a slide or set of slides as well as scattered replicates of arrayed probes in a single well. These compositions and methods can be used to perform multiplexed assays for analytes in patient and other test samples. In particular, these methods have applications for Quantitative Multi-analyte Immunoassays (QMI) to measure proteins in human serum and plasma.

Arrays are generally fabricated by the immobilization of biomolecules at discrete sites on a surface functionalized with polymer hydrogels, aminosilanes, nitrocellulose, aldehyde-silanes, or epoxysilane. Besides photolithographic methods, robotic spotters are now the most common instrument used for creating arrays. Most protein microarray facilities now use non-contact piezoelectric robotic spotters manufactured by companies such as Perkin-Elmer (Piezo Array), GeSim (NanoPlotter), Scienion and Aushon. Very high-density microarrays containing over one-hundred Ab can be prepared using robotic spotters.

Readout of the array can be accomplished using an optical detector such as a microarray scanner (e.g. a confocal laser scanner), surface plasmon resonance instrument (including imaging), luminescence reader, microtiter plate reader or an optical waveguide fluorescent reader. In many cases, the bound molecule of interest must be labeled in some way to make it detectable, such as with a fluorescent molecule, to generate an optical signal. Radioactive signals can also be used as a transducer to achieve readout, though this approach is less common for obvious reasons. Detection of optical signals is achieved using a variety of methods in these instruments, including CCDs, CMOS chips, and/or PMTs. The concentrated light energy in an optical waveguide can be used to excite fluorescently labeled molecules with higher signal-to-noise than conventional approaches. This excitation (and the concomitant emission of light) is used to detect the presence of fluorescently labeled molecules in solution (like proteins or DNA) at very low levels.

Fluorescence detection is the current method of choice for microarray applications, as it is a well understood and widely accessible method, and yields superior sensitivity with minimal complications. As a result, there is a well established infrastructure of fluorescence imagers and quantification software for microarray analysis. Recent advances in fluorescent chip imagers have made them capable of reading large format slides with microplates attached, at a price affordable (˜$80,000) to researchers. These include Alpha Innotech's NovaRay Scanner, Tecan's LS Reloaded Scanner, and Applied Precision's arrayWoRx multi-format reader. Some of these instruments are compatible with the robots that transfer plates between automated liquid handling systems.

Once read by a scanner or imager, the array readout must be processed in order to transform the image into quantitative data. Many software programs exist for array image processing, including ArrayVision (Imaging Research Inc/GE Healthcare Life Sciences), ScanArray Express (PerkinElmer Life Sciences Waltham, Mass.), MicroVigene (VigeneTech. Inc, Carlisle, Mass.). These programs include “spot finding” algorithms and turn microarray images into values. These programs often have features that subtract array background noise from spot values. Once values are obtained for each spot, values from standard calibration curves can be used to generate a curve-fit, from which the user can back-calculate the concentration of analytes in the sample of interest.

In other embodiments, the readout of the array is accomplished via use of colorimetric reagents, such as gold catalyzed silver deposition, or any other calorimetric detection system.

Protein arrays are often used to measure protein abundance. Protein abundance is most commonly measured using protein capture molecules such as antibodies, aptamers, antibody fragments, and others. Capture molecules can be immobilized on surfaces and used to quantify protein abundance in a wide variety of samples, including saliva, blood, plasma, serum, urine, cell lysates, tissue, or other biological fluids. Fluorescence-, luminescence-, and colorimetric-based detection using planar arrays have proven to be highly sensitive and rapid methods for multiplexed protein detection. The attractive cost, use of less sample, improvement in efficiency and chain-of-custody benefits of multiplexed protein measurement in a single sample has helped these assay become much more common, particularly measurements of cytokine proteins in human serum and plasma. However, problems with assay sensitivity and reproducibility persist and have limited the broader utility and hence acceptance of these assays.

Protein analytes can be detected using a variety of detection steps that may include detector antibodies (commonly a biotinlyated, fluorescent, or otherwise-labeled monoclonal or polyclonal antibody), secondary antibodies (such as a biotinlyated, fluorescent- or otherwise labeled anti-species antibody), and/or a detection reagent (such as fluorescent- or otherwise-labeled streptavidin, a substrate, or precipitate).

The efficiency of obtaining protein array results can be improved in several ways. Often, a single planar surface can contain multiple arrays to enable processing of standard calibration curves and/or multiple patient or test samples on a single slide. These multi-array surfaces are usually coupled to multiplexing devices (also called separators) that separate samples by forming multiple, independent chambers or wells. Examples of multiplexing devices include the ProPlate (Grace Bio-Labs, Inc. Bend, Oreg.), FASTframe (Publication # WO2005060678 or application Ser. No. 10/737,784), or SIMplex products (GenTel BioSciences, Madison, Wis.). Commonly, multiplexing devices separate a single 3″×1″ microarray slide into sixteen chambers (e.g. 2×8 format). The Proplate, FASTframe, and SIMplex64 devices secure four slides (sixteen chambers each) to form a sixty-four well device. These devices have been designed to fit within the standard footprint of a multi-well plate as established by the Society of Biomolecular Sciences (SBS Standards). The footprint for most multiwell plates is approximately 85 mm×125 mm with wells located in a standardized format depending upon the total number of wells. In this format, researchers can incorporate an eight-point standard curve- and process up to 56 samples using a single, 64-well plate. Alternatively, a researcher could incorporate two eight-point standard curves and process up to sixteen samples in triplicate using a single, 64-well plate to achieve higher precision.

More recently, researchers have coupled larger format slides to separators to emulate the 96-well plate format standard (U.S. Pat. No. 7,063,979, United States Patent Application 20050277145; each of which is herein incorporated by reference) established by SBS. This format has the advantage of being more fully compatible with robotic liquid handling instruments and enables the processing of additional samples. For example, a researcher could incorporate a single eight-point standard curve and process up to 88 samples using a single 96-well plate. In some embodiments, the current invention utilizes a single slide in a 96-well configuration. In some embodiments, the single slide is the same size as a 96-well plate and arrays are printed within the areas on the slide corresponding to the wells of a 96-well plate. The slide may be made of any suitable material and is preferably glass, silicon, plastic or some other polymer. In some embodiments, the slide is coated with a material suitable for application of a microarray, such as a protein or nucleic acid microarray. In some embodiments, the slide is coated with nitrocellulose, PVDF, or other suitable material. In some preferred embodiments, the coating is less than about 1000 nm in thickness, and preferably less than 500 nm in thickness. In some preferred embodiments, the 96-well single slide format is the APIX™ system available from GenTel Biosciences, Madison, Wis.

All of these multiplexing methods allow sample processing using automated liquid handling robots to enable rapid and efficient collection of multi-analyte data from many samples. Additionally, automation helps reduce assay variation (thus enabling more precise quantitation).

While planar DNA microarrays are widely used for the analysis of the expression of multiple genes, DNA microarray data does not reflect the amount of proteins translated, as there is often poor correlation between gene expression and corresponding protein abundance.

The need for multiplexed protein assays is driven by several factors, but one of the most compelling reasons for measuring protein abundance in multiplex is the search for and validation of protein biomarkers. Protein biomarkers are specific molecules found in the body whose presence can indicate a particular disease state. Prostate specific antigen (PSA) is one of the most well-known biomarkers; detection of elevated PSA levels in a blood sample may indicate prostate cancer. Biomarkers now serve as indicators for a wide variety of diseases, including cancer and autoimmune and inflammatory diseases such as rheumatoid arthritis, multiple sclerosis and lupus. The search for protein biomarkers with predictive value for disease requires multi-protein assays and large sample sets.

Recently, new clinical applications of biomarkers have emerged, including differential diagnosis of a disorder or identification of a patient subset, identification of potential responders to a specific drug, targeting of specific therapies, identifying individuals at risk for adverse events, and monitoring individual responses to drugs. These applications require very robust protein quantification technologies with high levels of accuracy and precision to meet this need.

Accordingly, in some embodiments, the present invention provides methods to normalize microarray data across different wells and within a single well.

### I. Normalization Reagents

In some embodiments, the present invention provides methods and compositions for improving microarray data comprising the use of normalization reagents. For example, in some embodiments, a normalizing reagent is spiked into each well on the slide at a concentration constant throughput the multiple wells, slides, and between experiments. When the normalizing reagent is captured by an immobilized probe molecule and subsequently detected, the signal of all other probes in the same well can be normalized based on the signal produced by the normalizing reagent. In this way differences in protein quantification that may be caused by “hot” or “cold” wells or slides, or by variations in instruments, users, or with time can be mitigated thereby increasing assay sensitivity, accuracy, and precision.

In some cases, the normalizing reagent is a protein (e.g., β-galactosidase). For example, in experiments conducted during the course of development of embodiments of the present invention, β-galactosidase was utilized as a normalizing reagent. β-galactosidase is well suited for use with human samples because there is no analogous protein present in humans, making it less likely to cause assay interference or cross-reactivity. However, the present invention is not limited to the use of β-galactosidase. Additional normalizing reagents may be utilized and are known to those of skill in the art.

In some embodiments, a capture antibody specific to the reporter protein is included in the printed microarray. In some embodiments, appropriate amounts of normalization reagent are spiked into sample dilution buffers and standard dilution buffers such that the final concentration of the normalization reagent is equivalent in all wells, including standards, sample testing wells, and/or quality control wells. In some embodiments, a biotinylated detection antibody is included in the detector antibody cocktail such that binding of the normalization reagent can be visualized with a detection reagent such as streptavidin DY547.

The normalization methods of the present invention find use in any number of protein detection assays. In one exemplary embodiment, the normalization methods of the present invention are an array of immobilized antibodies designed to quantify cytokines present in human plasma or serum. For example, in experiments conducted during the course of development of embodiments of the present invention normalization using β-galactosidase was used in protein assays for measuring fourteen human cytokines in human serum or plasma (See e.g., Example 1).

In other embodiments, normalizing reagents are used to improve microarray data additional arrays including, but not limited to, arrays of proteins, single-capture (non-sandwich) array assays, lectin arrays, peptide arrays, or lysate arrays. For example, if proteins are immobilized in a microarray to enable the detection of protein-specific antibodies present in a complex solution as detected by a secondary antibody, a reporter protein can be included in the microarray to capture an antibody specific to that protein. The captured protein can then be detected by a secondary antibody in a parallel fashion and the signal in each well or each slide can be normalized based on the signal produced at the reporter protein probe spots. Thus, normalization of this type reduces assay variability caused by “hot” or “cold” wells or slides, or by variations in instruments, users, or with time. It is expected that such a strategy would result in increased assay sensitivity, accuracy, and precision for single-capture assays.

In one non-limiting example of a protein array assay that would use this configuration, an array of immobilized allergens can be designed to quantify IgE's present in human serum. This assay can be used to diagnose the presence and/or severity of specific allergies in a patient based on the quantity of IgE's specific to an allergen in the array.

Another example of this type of assay is an array of immobilized antigens associated with a specific disease or several diseases designed to quantify antibodies or auto-antibodies generated by the immune system in response to the elevated presence of antigens associated with disease. This type of protein assay can be used to detect auto-antibodies generated in response to the presence or elevation of cancer- or tumor-related proteins.

An additional example of a protein array assay that would use normalization is a single-capture antibody array. Single-capture (also called high-density) antibody arrays, are not limited by cross-reactivity between detector antibodies and analytes, and can therefore contain as many as several hundred antibody probes on a single chip. Single-capture antibody arrays capture proteins that have been directly labeled and incubated on the array and enable users to reproducibly screen for changes in protein abundance between samples. To improve data quality, results are normalized using a reporter reagent or normalization reagent. The normalization reagent is spiked into serum prior to labeling at a known concentration.

### II. Scattered Replicate Spots

In some embodiments, the present invention provides methods and compositions for improving assay performance that utilize scattered replicate spots of assay components (e.g., test assay components or positive control assay components). In some embodiments, assay components on a microarray are scattered across substrates (e.g., substrates containing single or multiple microarrays). In other embodiments, samples (e.g., test or control samples) are scattered across substrates. In some embodiments, the assay components or samples are scattered across multiple “wells” on a 96-well single slide format as described above.

For example, in some embodiments, scattered replicate spots within a well are used to reduce variability. In most cases, replicate spots are printed in a linear fashion. Printing in linear fashion is the simplest method in terms of both assay fabrication and data analysis, and with little exception is the most commonly used format in the generation of protein arrays. One primary reason that arrays are not fabricated with scattered replicate spots lies in the difficulty in reprogramming array printers. Additionally, some widely used software programs are not configured for nor can they be easily be adapted to analyze data generated in a scattered layout. Accordingly, in some embodiments, the present invention provides systems and software that are suitable for the printing and analysis of scattered array layouts.

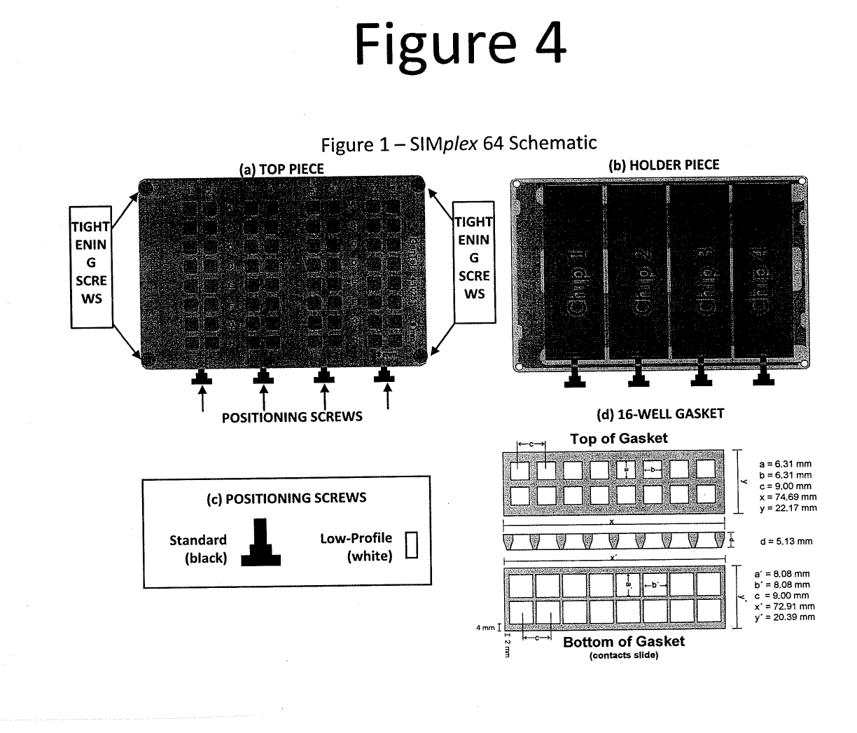

In other embodiments, test and control samples are further scattered in replicate. In some embodiments, scattered test samples and replicate test samples, scattered standards and replicate standards, and scattered samples spiked with quality control standards (“samples”) are used to reduce variability in an array-based assay. In some embodiments, samples are scattered throughout multiple wells (e.g. 16-wells) formed on a single 3″×1″ microscope slide. In other embodiments, samples are scattered within a multi-slide cassette such as a 4-slide cassette, where each slide is divided into multiple wells (e.g. 16-wells) formed on each 3″×1″ microscope slide. This is shown in FIG. 3. In some embodiments, sample application is automated.

In other embodiments, samples are scattered throughout multiple wells (e.g. 96-wells) formed on a single 3″×5″ large-format slide that is compatible with automated liquid handlers.

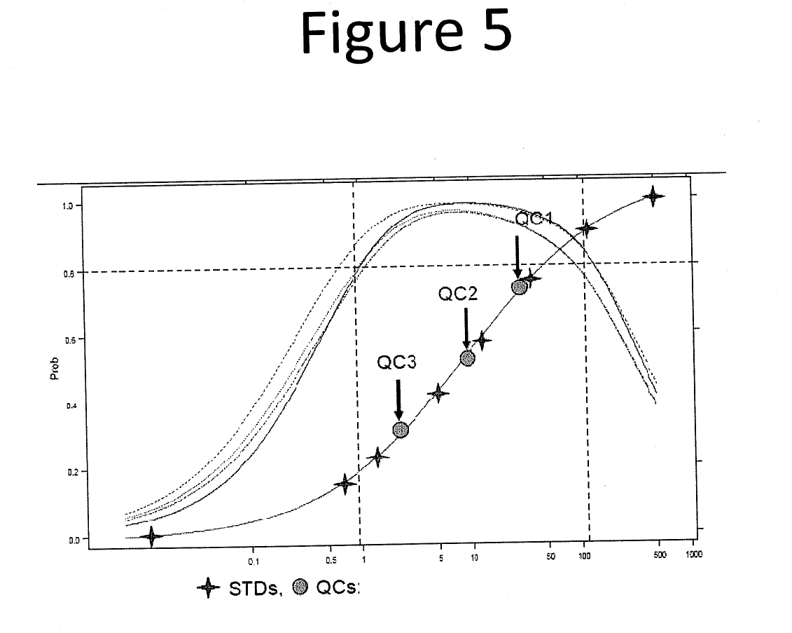

Generally, the well-forming portion of the 4-slide cassette is removed before a slide is scanned. This portion of the 4-slide cassette is shown as the TOP PIECE and GASKET in FIG. 4. In some cases, the well forming portion of either the 4×16-well slide cassette and/or the 96-well large format device is designed so that the slides can be scanned without separating the slides from the well-forming device. To do this, wells are no deeper than 4-5 millimeters from the surface of the array to allow other scanners to get close enough for a measurement.

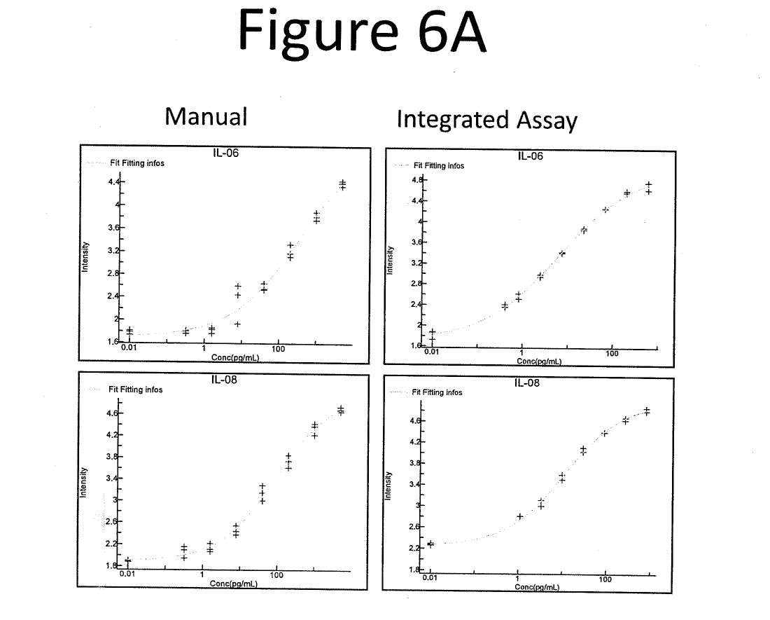

An additional aspect of the invention is the inclusion of standards spiked into the assay matrix to act as QC points. In some embodiments, analysis of analytes in a biological matrix is carried out using samples spiked with calibration (reference) standards and using quality control (QC) samples. The recovery of these spiked samples referenced to their expected concentration are used to ensure quality of the assay. In some embodiments, such QC points are performed at high, medium, and low concentrations relative to physiological concentration of the analyte. An example of this is shown in FIG. 5.

### III. Kits and Systems

In some embodiments, the present invention provides kits and systems for performing and analyzing array data. In some embodiments, the kits and systems comprise all of the components necessary, sufficient, or useful for generating, performing and analyzing arrays. For example, in some embodiments, kits and systems include all of the substrates (e.g., arrayed substrates), reagents, components, buffers, normalization standards, and controls needed for performing assays. In some embodiments, kits and systems further comprise software for collecting and analyzing data from arrays. In some embodiments, kits and systems comprise instructions for using the kits. In some embodiments, systems comprise automation equipment (e.g., robotics, etc.) for automating assays.

### EXPERIMENTAL

The following examples are provided to demonstrate and illustrate certain preferred embodiments and aspects of the compositions and methods disclosed herein, but are not to be construed as limiting the scope of the claimed invention.

### Example 1

### Normalization

This Example describes the use of internal normalization standards. Capture antibodies to fourteen human cytokines were printed in sixteen sub-arrays on a four microscope slides modified with translucent nitrocellulose. The standard dilution curve was spiked with β-galactosidase normalization reagent such that the final concentration of β-galactosidase was equivalent in all wells. Arrays were processed using detector antibody cocktails and detection was accomplished using streptavidin DY547.

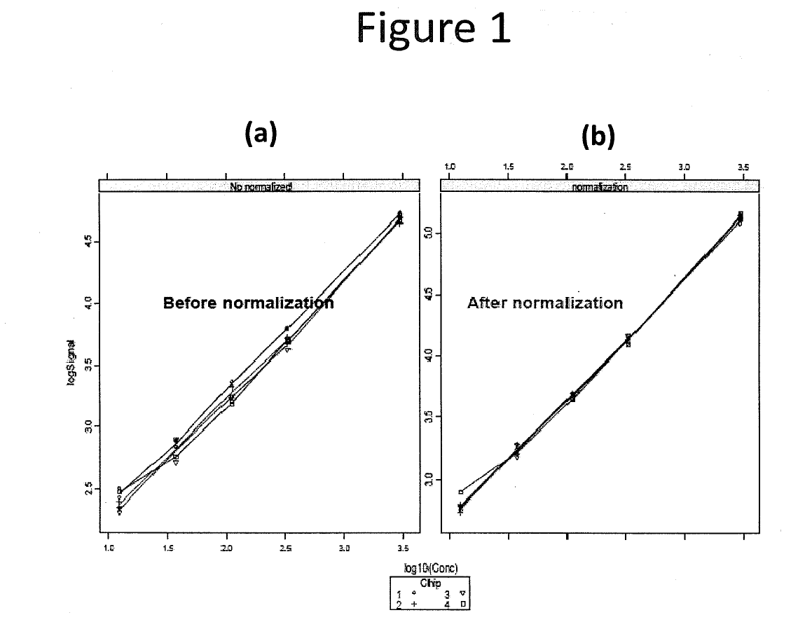

Standard curves were generated on all four slides before and after normalization using the reporter protein signal. Standard curves generated before data normalization are shown in FIG. 1(a) and after data normalization in FIG. 1(b). It can be noted from these data that after normalization, the standard curves from the four slides overlap much more closely.

Further quantitative analysis indicated significantly improved reproducibility and sensitivity resulting from the normalization process. This is evident in the comparison of the limit-of-detection (LOD), limit-of-quantitation (LOQ), coefficient of variation (CV), and goodness-of-fit (R²) for the two approaches. LOD was calculated using the blank signal plus two standard deviations in a 4-parameter fit of the standard curve. LOQ was calculated using the blank signal plus eight standard deviations in a 4-parameter fit of the standard curve. Table 1 shows the calculated LODs and LOQs for fourteen human cytokines on the panel with and without normalization. It is evident from these data that normalization of the standard curves significantly improves sensitivity. Table 2 shows calculated CVs and R² for the fourteen human cytokines with and without normalization. Again, it is evident from these data that the normalization process significantly improves assay reproducibility and results in a better curve fit.

TABLE 1

| | LOQ pg/ml | | LOD pg/ml | |
|---|---|---|---|---|
| Analyte | normalized | not normalized | normalized | not normalized |
| GM-CSF | 13.09 | 20.18 | 0.82 | 1.63 |
| IFNg | 1.21 | 3.62 | 0.08 | 0.28 |
| IL-01b | 1.12 | 4.73 | 0.07 | 0.34 |
| IL-02 | 0.88 | 1.86 | 0.04 | 0.12 |
| IL-03 | 52.34 | 128.23 | 7.67 | 22.43 |
| IL-05 | 1.74 | 4.54 | 0.15 | 0.50 |
| IL-06 | 2.29 | 4.30 | 0.17 | 0.41 |
| IL-07 | 1.40 | 4.70 | 0.13 | 0.47 |
| IL-10 | 0.05 | 0.26 | 0.00 | 0.01 |
| IL-12 | 40.07 | 140.92 | 4.02 | 16.06 |
| MCP-1 | 2.16 | 3.18 | 0.26 | 0.44 |
| TNFa | 25.91 | 67.83 | 3.66 | 12.61 |
| TNFb | 1.28 | 5.17 | 0.05 | 0.24 |
| VEGF | 14.20 | 41.04 | 1.28 | 4.39 |

TABLE 2

| | cv slide to slide | | R² slide to slide | |
|---|---|---|---|---|
| Analyte | normalized | not normalized | normalized | not normalized |
| GM-CSF | 11.36 | 12.58 | 0.997 | 0.996 |
| IFNg | 7.18 | 10.79 | 0.999 | 0.998 |
| IL-01b | 8.80 | 15.58 | 0.999 | 0.996 |
| IL-02 | 9.06 | 11.02 | 0.999 | 0.998 |
| IL-03 | 7.84 | 12.57 | 0.998 | 0.995 |
| IL-05 | 7.06 | 10.12 | 0.999 | 0.997 |
| IL-06 | 9.64 | 11.69 | 0.998 | 0.997 |
| IL-07 | 10.54 | 18.39 | 0.998 | 0.995 |
| IL-10 | 7.78 | 11.44 | 0.999 | 0.998 |
| IL-12 | 8.31 | 15.30 | 0.999 | 0.995 |
| MCP-1 | 10.16 | 11.59 | 0.998 | 0.998 |
| TNFa | 10.12 | 17.89 | 0.995 | 0.983 |
| TNFb | 9.46 | 14.76 | 0.998 | 0.996 |
| VEGF | 12.21 | 19.85 | 0.996 | 0.989 |

### Example 2

### Scattered Replicate Spots

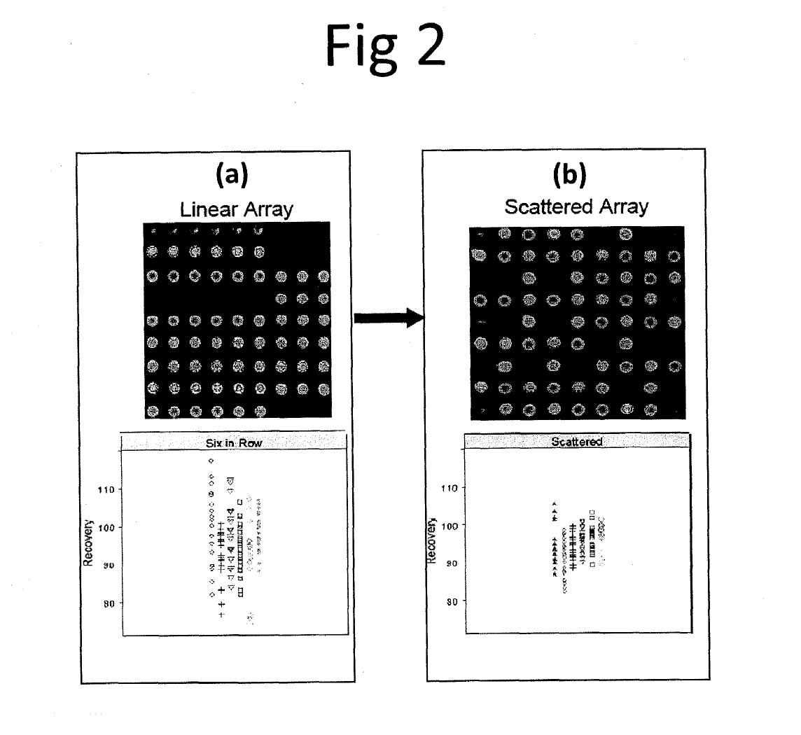

This example describes the use of scattered replicate spots. Arrays were printed that contained antibodies to thirteen different cytokines in linear and scattered array formats and a sandwich assay was performed that was similar to the human cytokine assay performed above (Example 1) to measure recovery of analyte spiked into a sample matrix. Six replicate spots were used. An image of the array printed in linear fashion and a scattered fashion is shown in FIGS. 2(a) and 2(b), respectively. Recovery data, shown below for each printing configuration, is shown below the array image. It is clear that printing in a scattered format results in less data scatter and, in general, recovery is closer to 100% when assays are performed using scattered replicates in an array.

The present invention is not limited to a particular mechanism. Indeed, an understanding of the mechanism is not necessary to practice the present invention. Nonetheless, it is contemplated that the benefits of scattered replicates spots in a single well is due to the fact that microarray slides have inherent non-uniformities in their surface chemistry that may lead to higher or lower signal based on location of the spot in the array. It is further contemplated that scattering replicate spots has the effect of averaging these differences across several replicates and probe types, rather than concentrating them in a particular data set.

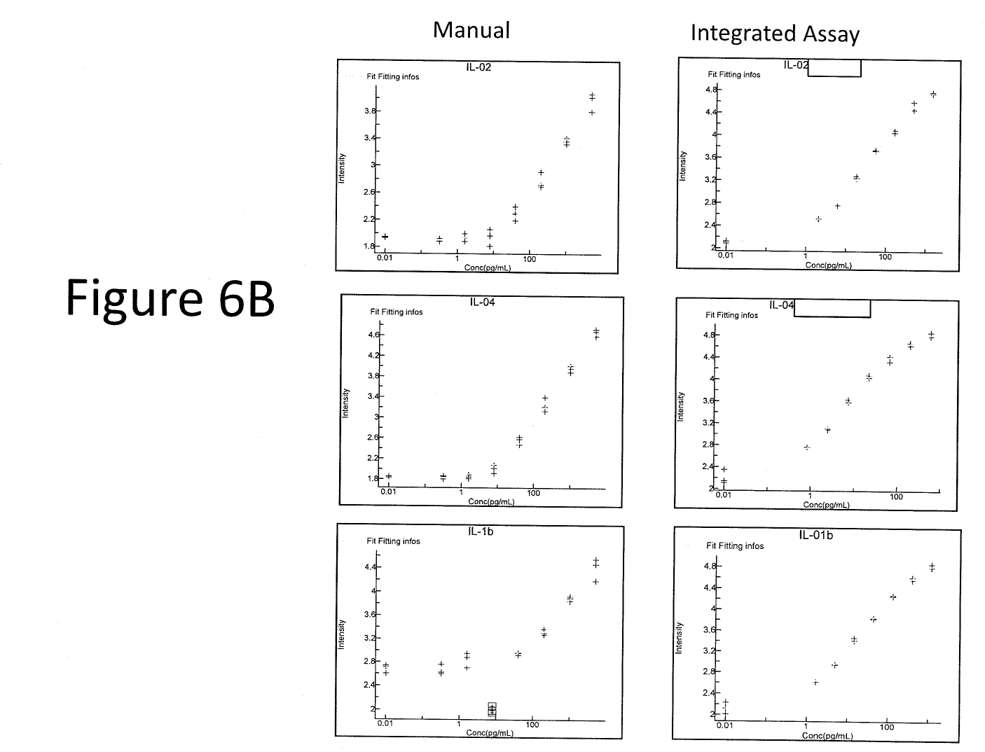

An assay was next performed using standard manual methods and compared to an automated assay that integrates normalization, scattered spot replicates, and scattered layout of samples on chips (integrated assay). FIG. 6 shows graphs of standard curves show that the integrated assay improves reproducibility significantly compared to a standard manual assay. In Table 3, calculated LODs and LOQs are shown for five human cytokines on the panel using standard manual methods versus the integrated assay. Based on these data, it is evident that use of the integrated assay significantly improved the sensitivity and precision of a sandwich assay.

| Manual | | | | Integrated Assay | | | |
|---|---|---|---|---|---|---|---|
| Manual | LOD | LOQ | Rsqaured | Integrated | LOD | LOQ | Rsqaured |
| IL-1b | 27.9 | 393.7 | 0.977 | IL-01b | 0.05 | 0.82 | 0.998 |
| IL-02 | 12.2 | 144.3 | 0.987 | IL-02 | 0.12 | 1.89 | 0.997 |
| IL-04 | 3.1 | 39.7 | 0.994 | IL-04 | 0.02 | 0.40 | 0.997 |
| IL-06 | 2.3 | 83.9 | 0.980 | IL-06 | 0.01 | 0.14 | 0.998 |
| IL-08 | 0.9 | 13.8 | 0.993 | IL-08 | 0.04 | 0.61 | 0.996 |

### Example 3

### Der p 2 Mediated Quantitative Determination of Allergen-Specific IgE in Human Serum

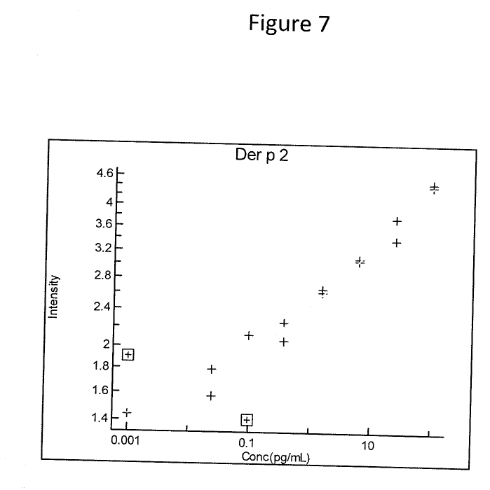

This example describes the use of a Chimeric anti-Der p 2 Immunoglobulin E (IgE) as a surrogate for making quantitative determinations encompassing a large range of allergen-specific IgE titers in patient serum. A Der p 2 standard curve was used as a comparison for the quantitation of several common allergens (FIG. 7). Der p 2 protein and other test antigens were immobilized on a microarray. B-galactosidase was immobilized in replicate as an internal normalization standard. After contact with serum, a biotinylated anti-human IgE-IgG was used for detection using streptavidin.

This system was used to accurately predict allergen-specific IgE titer from Cat (Fel d 1), Silver Birch (Bet v1, Bet va), Timothy Grass (Phl p 1, Phl p 2, Phl p 5a, Phl p 6), mold (Alternaria alternata) (Alt a 1), dust mite (Der p 1, Der p 2, Der f 1), Dog (Can f 1). The experiment included comparison to Quantitative levels determined by a third party using a legacy assay called UNICAP (now IMMUNOCAP) assay. The sensitivity measurements Defined as True Positives—UNICAP assay positives reached 89%. Concurrent specificity measurements reached 80%. These numbers reflect the instances that the assay described herein, employing the quantification methods described herein was able to predict levels that fell into the same class as the UniCAP data. Results are shown in Tables 3 and 4.

In summary, the chimeric anti-Der p 2 IgE (Indoor biotechnologies) is able to accurately predict the concentrations of many allergen-specific IgE's representing many different allergies. The use of this system allows for quantitative measurements of many allergen-specific IgEs and leads to a rapid predictive test for many different allergic conditions.

TABLE 3

| Assay | Sample | | | | | | | | |
|---|---|---|---|---|---|---|---|---|---|
| ID | ID | D. pteronyssinus | D. farinae | F. domesticus | A. alternata | C. familiarus | B. pendula | P. pratense | B. germanica |
| UniCAP | #009 | 34.000 | 36.300 | 1.500 | <0.35 | 1.380 | 6.240 | 3.060 | <0.35 |
| Automated 1 | #009 | 55.175 | 43.640 | 0.719 | <0.024 | 1.393 | 8.056 | 8.627 | 0.027 |
| Automated 2 | #009 | 49.076 | 40.136 | 0.592 | <0.024 | 1.201 | 7.281 | 7.980 | <0.024 |
| Automated 3 | #009 | 64.287 | 46.459 | 1.171 | <0.024 | 1.245 | 5.419 | 5.979 | <0.024 |
| Automated 4 | #009 | 39.630 | 23.868 | 0.619 | <0.024 | 0.964 | 4.809 | 6.229 | <0.024 |
| Automated 5 | #009 | 57.329 | 40.719 | 1.202 | <0.024 | 1.292 | 5.802 | 6.322 | <0.024 |
| Automated 6 | #009 | 38.866 | 23.798 | 0.745 | <0.024 | 1.157 | 5.243 | 6.540 | <0.024 |
| Manual 1 | #009 | 88.993 | 60.215 | 4.263 | <0.024 | 2.290 | 11.698 | 26.372 | <0.024 |
| Manual 2 | #009 | 121.341 | 82.758 | 6.566 | <0.024 | 3.500 | 16.542 | 35.662 | <0.024 |
| Manual 3 | #009 | 137.680 | 97.470 | 3.680 | <0.024 | 3.587 | 20.015 | 18.284 | 1.448 |
| | | Class 0 | 0.00-0.34 | | | | | | |
| | | | IU/mL | | | | | | |
| | | Class 1 | 0.35-0.69 | | | | | | |
| | | | IU/mL | | | | | | |
| | | Class 2 | 0.7-3.4 | | | | | | |
| | | | IU/mL | | | | | | |
| | | Class 3 | 3.5-17.4 | | | | | | |
| | | | IU/mL | | | | | | |
| | | Class 4 | >17.4 | | | | | | |
| | | | IU/mL | | | | | | |

TABLE 4

| | | | |
|---|---|---|---|
| | | | Well to |
| Assay Method | Sensitivity | Specificity | well C.V. |

All allergens included in calculations

| | | | |
|---|---|---|---|
| Automated with Normalization | 77.8% | 86.0% | 22.45% |
| Manual without Normalization | 64.8% | 68.9% | 33.70% |

Calculations done without Can f 1, Bla g 1, Bla g 2, Bla g 4, Bla g 5

| | | | |
|---|---|---|---|
| Automated with Normalization | 88.9% | 83.7% | 22.45% |
| Manual without Normalization | 73.3% | 58.8% | 33.70% |

We claim:

1. A method for performing an assay, comprising performing a multiplexed assay for detection of a biological macromolecule using an internal normalization standard under conditions such that the concentration of said internal normalization standard is used to normalize assay results across different locations of said array.

2. The method of claim 1, wherein said assay is a multiplexed assay.

3. The method of claim 2, wherein said multiplexed assay is a microarray.

4. The method of claim 1, wherein said assay is an immunoassay.

5. The method of claim 1, wherein said internal normalization standard is β-galactosidase.

6. A method for performing an assay, comprising contacting a substrate comprising at least one microarray with a test sample, wherein said microarray comprises a plurality of replicate assay components located on said microarray, wherein said replicate assay components are scattered across individual location on said microarray.

7. The method of claim 6, wherein said array comprises a platform selected from the group consisting of a slide and a cassette.

8. The method of claim 6, wherein said substrate comprises two or more microarrays.

9. The method of claim 6, wherein said assay components are selected from the group consisting of positive control assay components and test assay components.

10. The method of claim 6, wherein said test samples are applied in replicate scattered across said at least one microarray.

11. The method of said 6, wherein said method further comprises the step of contacting said microarray with a plurality of standards, wherein said standards are applied in replicate scattered across said at least one microarray.

12. The method of claim 6, further comprising the step of adding a normalization reagent to each of said locations on said microarray.

13. The method of claim 12, wherein said normalization reagent is β-galactosidase.

14. The method of claim 6, wherein each of said test samples comprises a quality control standard.

15. A substrate comprising a protein microarray, said microarray comprising a plurality of replicate assay components located on said microarray, wherein said replicate assay components are scattered across individual location on said microarray.

16. The substrate of claim 15, wherein said substrate comprises two or more microarrays.

17. A kit comprising a substrate for performing a protein microarray, said substrate comprising at least a first microarray comprising a plurality of replicate assay components located on said microarray, wherein said replicate assay components are scattered across individual location on said microarray.

18. The kit of claim 17, wherein said substrate comprises two or more microarrays.

19. The kit of claim 17, wherein said kit further comprises a normalization reagent.

20. The kit of claim 19, wherein said normalization reagent is β-galactosidase.

21. The kit of claim 17, wherein said kit further comprises a software program configured to analyze microarray image data generated from said array.

22. The kit of claim 17, wherein said assay components are selected from the group consisting of positive control assay components and test assay components.

23. A system for performing a microarray assay, comprising
a) a plurality of assay components;
b) a substrate for performing a microarray assay, wherein said substrate comprises at least a first microarray comprising a plurality of replicate assay components located on said microarray, wherein said replicate assay components are scattered across individual location on said microarray; and
c) a normalization reagent.

24. The system of claim 23, wherein said assay components are selected from the group consisting of positive control assay components and test assay components.

25. The system of claim 23, wherein said normalization reagent is β-galactosidase.

26. The system of claim 23, wherein said system further comprises an automation device configured for automation of the generation of said microarray.

27. The system of claim 23, wherein said system further comprises software for analysis of said assay.
